(19) United States
(12) Patent Application Publication
(10) Pub. No.: US 2007/0190815 A1
(43) Pub. Date: Aug. 16, 2007

(54) CABLE MANAGEMENT BAR

(76) Inventors: Roderick Sampson, Lake Wylie, SC (US); Sidney E. Turner, Pointe-Claire, Quebec (CA)

Correspondence Address: LADAS & PARRY LLP, 224 SOUTH MICHIGAN AVENUE, SUITE 1600, CHICAGO, IL, 60604, US

(21) Appl. No.: 11/625,479

(22) Filed: Jan. 22, 2007

Related U.S. Application Data
(60) Provisional application No. 60/760,387, filed on Jan. 20, 2006.

(30) Foreign Application Priority Data
Jan. 20, 2006 (CA) 2533486

(51) Int. Cl. H01R 29/00

(52) U.S. Cl. 439/49

(57) ABSTRACT

A cable management bar is disclosed for attachment in front of a panel for supporting a plurality of cables, typically telecommunication cables, which are terminated at a plurality of sockets in the panel. The bar comprises an elongate cable supporting portion and at least one mounting bracket for securing the cable supporting portion. Cable management bar can be hinged relative to the front face of the panel such that it can be moved between a cable supporting position and a panel accessing position. There is also disclosed a cable guide for guiding the cables as they pass over (or under) the cable management bar.

### CROSS REFERENCE TO OTHER APPLICATIONS

This application claims priority on U.S. Provisional Application No. 60/760,387, filed on Jan. 20, 2006 which is herein incorporated by reference in its entirety.

### FIELD OF THE INVENTION

The present invention relates to a cable management bar. In particular the present invention relates to a cable management bar for supporting cables being terminated at equipment such as distribution panels and patch bays or the like typically supported in a cable management rack.

### BACKGROUND TO THE INVENTION

In the networking environment, racks are used to install active equipment (switches, servers, etc), cross connecting equipment (patch panels, mini racks, cable management, etc) and other required equipment. Such racks are installed in main telecom rooms, telecom closets and in data centre environments. These environments are limited in space and there are a limited number of racks that can be installed in these confined environments. As such, the in-rack space is also limited. The growth of today's data networking is calling for more connections within the same limited space, hence the trend toward higher density and better utilization of rack space.

The majority of current installations implement cable management solutions which occupy prime in-rack space, for example through the use of channels positioned in between adjacent pieces of networking equipment or patch bay panels. This space could otherwise be used for cross connecting patch panels or other networking equipment and as a result the density of connections per rack is not optimised.

### SUMMARY OF THE INVENTION

In order to address the above and other drawbacks, there is disclosed a cable management bar for attachment in front of an elongate panel mounted on a rack comprising a pair of vertical rails spaced at a predetermined distance from each other and bordering a surface, the panel comprising a face comprising a plurality of cable terminating elements therein, each of the elements terminating one of a plurality of cables. The bar comprises an elongate cable supporting portion and at least one mounting bracket for securing the cable supporting portion to one of the rails. A first distance between the surface and a first point along the cable supporting portion is less than a second distance between the surface and a second point along the cable supporting portion, the second point positioned farther from the mounting bracket than the first point.

There is also disclosed a panel comprising a face comprising a plurality of cable terminating elements, each of the elements adapted for terminating a cable. The panel comprises a cable management bar comprising at least one elongate cable supporting portion positioned in front of the face and a first end positioned to one side of the face. The cable management bar is pivotable about the first end between a cable supporting position where the at least one elongate section is positioned directly in front of the face and a face accessing position wherein the at least one elongate section is positioned away from the face.

Furthermore, there is disclosed a cable guide for guiding one of a plurality of cables being supported by a cable management bar. The guide comprises a cable receiving portion for suspending the cable therein, and an identification tag associated the cable receiving portion.

Additionally, there is disclosed a cable guide for supporting at least one cable having a cable diameter between a vertical conduit and a respective one of at least one terminating elements in a horizontal panel mounted between a pair of vertical rails. The guide comprises an elongate member comprising a cable supporting edge, a bracket at one end of the member for securing the member to one of the rails and a raised lip at an opposite end of the member from said bracket, said lip preventing the at least one cable from being removed from said cable supporting edge without raising the cable. When installed on the rack underneath and adjacent to a second like guide, an upper edge of said lip and a lower edge of a member of the second guide define a gap having a width which is greater than the cable diameter.

Also, there is disclosed a method of simultaneously interconnecting a plurality of cables with a panel, the panel comprised of a plurality of equally spaced sockets arranged in a row and each of the plurality of cables being terminated by a plug. The method comprises providing a straight support bar comprising a row of equally spaced cable receiving portions arranged in a row along a surface thereof, wherein a spacing between adjacent cable receiving portions is the same as a spacing between adjacent ones of the equally spaced sockets, securing a respective one of the plurality cables at a position immediately adjacent the plug in each of the cable receiving portions, wherein all of the plugs terminating the cables are arranged on one side of the bar, and inserting the plurality of plugs into their respective sockets.

### BRIEF DESCRIPTION OF THE DRAWINGS

FIG. 1 is a front perspective view of a cable management rack in accordance with an illustrative embodiment of the present invention;

FIG. 2 is a detailed front right perspective view of a cable management rack in accordance with an illustrative embodiment of the present invention;

FIG. 3A is a left front perspective view of a patch panel in accordance with an illustrative embodiment of the present invention;

FIG. 3B is a front plan view of a patch panel in accordance with an alternative illustrative embodiment of the present invention;

FIG. 3C is a top plan view of a patch panel in accordance with an alternative illustrative embodiment of the present invention;

FIG. 3D is a right front perspective view of a patch panel in accordance with an alternative illustrative embodiment of the present invention;

FIG. 4A is a top plan view of a cable guide and support mounted on a cable management bar in accordance with an illustrative embodiment of the present invention;

FIG. 4B is a top plan view of a cable guide and support mounted on a cable management bar in accordance with an alternative illustrative embodiment of the present invention;

FIGS. 5A through 5F provide top plan views of patch panels and cable management bars in accordance with alternative illustrative embodiments of the present invention;

FIGS. 6A and 6B provide front plan views of patch panels and cable management bars in accordance with alternative illustrative embodiments of the present invention; and

FIG. 7 provides a top plan view of a patch panel and a pre-loaded cable management bar in accordance with an alternative illustrative embodiment of the present invention.

### DETAILED DESCRIPTION OF THE ILLUSTRATIVE EMBODIMENTS

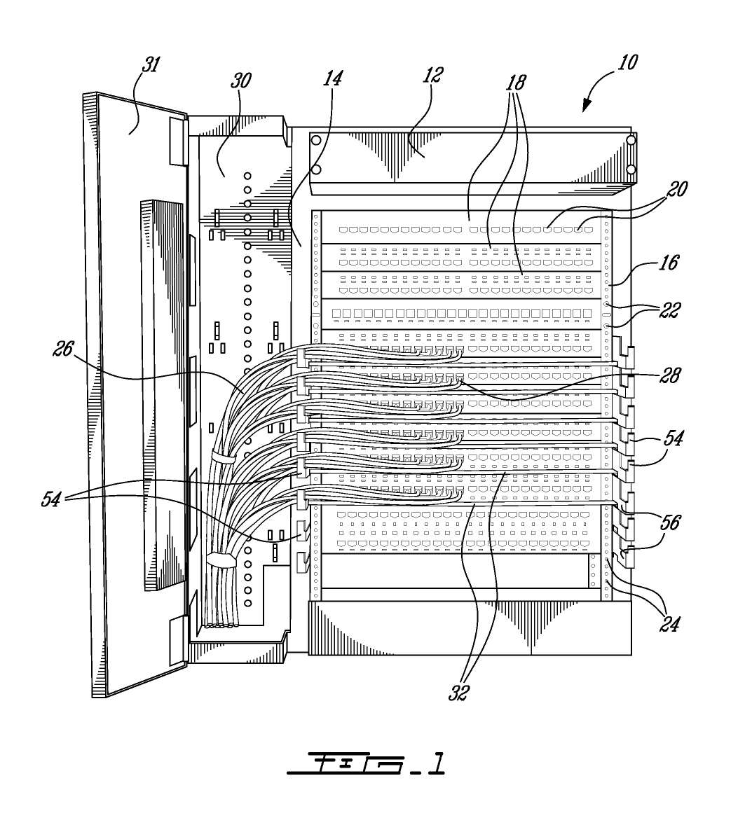

Referring now to FIG. 1, a cable management rack, generally referred to using the reference numeral 10, will now be described. The cable management rack 10 is comprised of a frame 12 comprised two vertical rails 14, 16 onto which a plurality of patch panels or other networking equipment as in 18 can be mounted. As known in the art, such patch panels as in 18 typically comprise a number of sockets (or modules) as in 20 and are independently mounted to the rack 10 by mounting hardware such as bolts as in 22 which mate with corresponding threaded holes as in 24 machined at intervals into the two vertical rails 14, 16. The sockets as in 20 are typically adapted to receive a cable as in 26 which is terminated by a standardised plug as in 28 such plugs conforming to the ubiquitous RJ-45 standard (although other technologies such as co-axial or those terminating fiber optic cables such as LC, SC or the like may also be terminated at such a rack).

Still referring to FIG. 1, the rack 10 may also include a conduit or channel 30 within which cables as in 26 can be gathered and bundled. The conduit 30 may also include a hinged door 31 providing easy access to the cables as in 18 within the conduit 30.

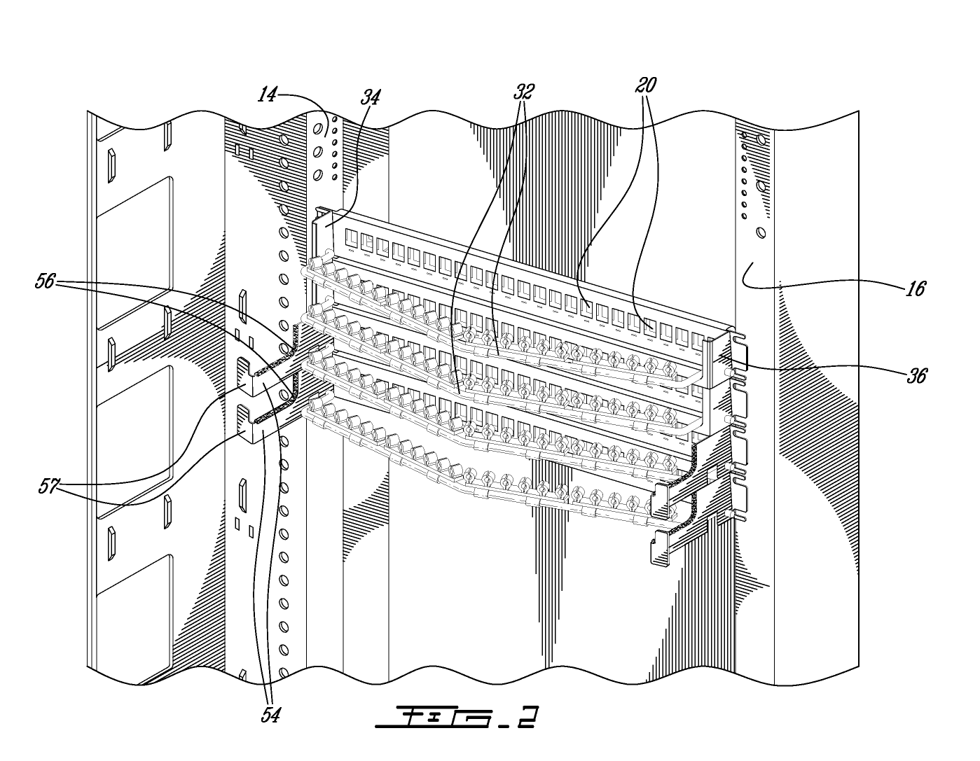

Referring now to FIG. 2 in addition to FIG. 1, each patch panel or piece of networking equipment as in 18 is provided with a cable management bar as in 32 mounted in front of the sockets as in 20. Each cable management bar as in 32 is typically manufactured from a material such as metal rod, moulded plastic or the like, capable of supporting the weight of a number of cables as in 26 and is secured at either end to the patch panel 18 or the rails 14, 16 by mounting brackets as in 34, 36. However, in an alternative illustrative embodiment the cable management bar 32 could be manufactured from a material having a limited flexibility as well as the ability to retain shapes introduced in to the cable management bar 32 by flexing, thereby providing an installer with the ability to customise the shape of the cable management bar 32 for a particular installation. Illustratively, the mounting brackets are separate from the patch panels as in 18 and co-mounted with the patch panels as in 18 to the vertical supports 14 using the same bolts as in 22. Alternatively, however, the brackets as in 34, 36 could be moulded or other wise integrated with the patch panels as in 18 or be moulded or otherwise integrated into either or both of the two vertical supports 14, 16. One advantage in stabilising the cables as in 26 by supporting them in this manner is that performance of the assembly is increased. Indeed, cables are often subject to forces which cause momentary disruptions in the interconnections (glitches), for example when an installer inadvertently touches a given cable during installation or reconfiguration of other cables in the same patch bay.

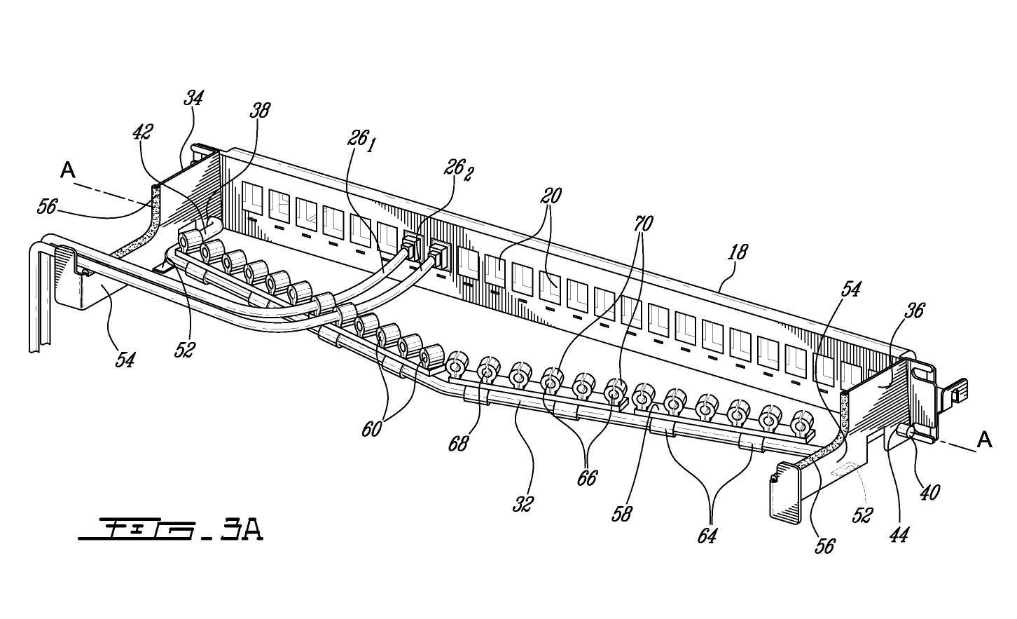

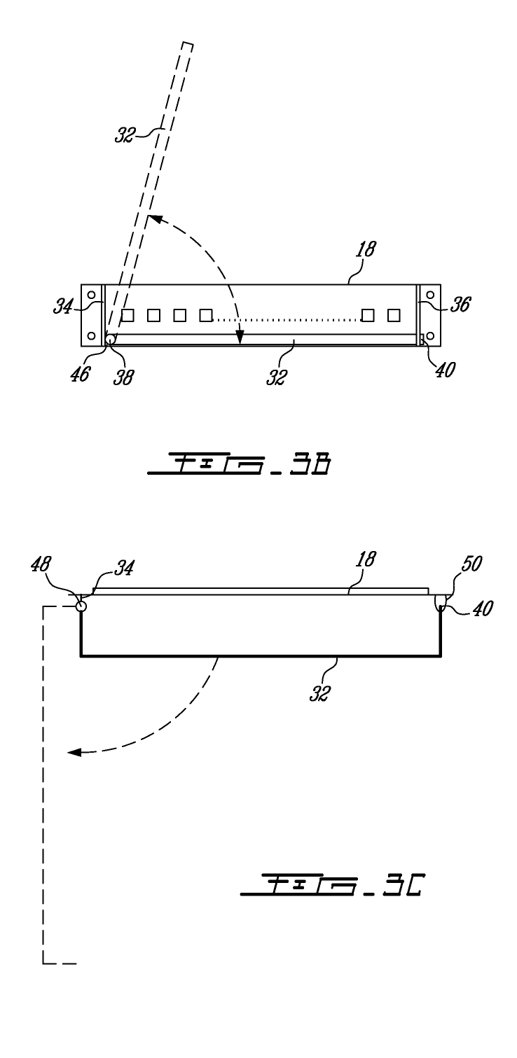

Referring now to FIG. 3A, as discussed above the cable management bar 32 is mounted together with the patch panel 18 using a pair of mounting brackets 34, 36. Illustratively the ends as in 38, 40 of the cable management bar 32 are mounted in corresponding holes as in 42, 44 machined, punched, or otherwise moulded in their respective mounting brackets 34, 36 and are adapted to pivot therein, thereby allowing the cable management bar 32 to be pivoted around an axis A from resting in a horizontal plane to a vertical plane. As a result, the cable management bar 32 can be moved such that access to the sockets as in 20 is improved. Additionally, in a particular embodiment the cable management bar 32 is manufactured from a material flexible enough to allow to allow the ends as in 38, 40 of the cable management bar 32 to be removed from their corresponding holes as in 42, 44, thereby allowing a given cable management bar as in 32 to be removed and installed at will.

Still referring to FIG. 3A, note that although the cable management bar 32 as illustrated is secured at both ends, in an alternative embodiment, and with a suitable robust mounting bracket, the cable management bar 32 could be secured at one or other of the ends as in 38, 40 to a respective one or other of the rails 14, 16 using a single bracket. Furthermore, although the cable management bar 32 is illustrated in FIG. 3A as being pivoted upward about the axis A between a horizontal cable supporting position and a vertical front face accessing position, in an alternative embodiment, and with the provision of a suitable locking mechanism (not shown) for securing the cable management bar 32 in the horizontal cable supporting position, the cable management bar 32 could be pivoted downward about an axis A between the horizontal cable supporting position and the vertical front face accessing position.

Referring now to FIG. 3B, note that, in an alternative illustrative embodiment, the first end 38 of the cable management bar 32 is securely mounted on a hinge 46 integrated with the first mounting bracket 34 and having an axis which is substantially at right angles to the front face of the patch panel, thereby allowing the cable management bar 32 to be rotated from a horizontal position to a vertical position, thereby providing access to the front face of the patch panel 18. Note that in this illustrative embodiment the second end 40 of the cable management bar 32 is illustrated as being releasably held in a vertical slot (not shown) machined or otherwise formed in the second mounting bracket 36. Alternatively, the hinge 46 further comprises a suitable limiting means for limiting the rotation of the cable management bar 32 between a horizontal cable supporting position and another, illustratively vertical, front face accessing positioning. Additionally, in this alternative embodiment the hinge 46 further comprises a locking mechanism for securing the cable management bar 32 in the horizontal cable supporting position.

Referring now to FIG. 3C, in still another alternative illustrative embodiment, the first end 38 of the cable management bar 32 is mounted on a hinge 48 integrated with the first mounting bracket 34 and having an axis which is substantially vertical, thereby allowing the cable management bar 32 to be rotated from a first horizontal cable supporting position to a second horizontal front face accessing position. Note that in this illustrative embodiment the second end 40 of the cable management bar 32 is illustrated as being releasably held by a securing mechanism 50 provided on the opposite side of the front face of the patch panel 18. Alternatively, the hinge 48 further comprises a suitable securing or locking means (not shown) for securing the cable management bar 32 in the horizontal cable supporting position.

Referring back to FIG. 3A, the mounting brackets 34, 36 further illustratively comprise a pair of ridges as in 52 which limit the cable management bar 32 to being pivoted upwards. Alternatively, the mounting brackets 34, 36 can be comprised of a means for releasably securing the cable management bar 32 in its horizontal plane or the cable management bar 32 can simply be mounted to the brackets such that it is not able to pivot, for example using welds or a suitable adhesive or the like.

Still referring to FIG. 3A, each of the mounting brackets 34, 36 can also illustratively comprise a cable bundle guide member as in 54. Referring back to FIG. 1 in addition to FIG. 3A, the cable bundle guide members 54 provide a support for the cables as in 26 as they move from a vertical orientation in the conduit 30 to a horizontal orientation in front of the sockets 20. In order to provide for a smoother bend of the cables 26 as they pass over the cable bundle guide members 54 and ensure that the cables are not otherwise damaged by the cable bundle guide members 54, the supporting edge provided by the cable bundle guide members 54 can be covered with a suitable protective insert or grommet 56, illustratively having a smooth convex surface and fabricate from a suitable non-conductive material such as rubber or plastic. In a particular embodiment, the protective insert 56 also covers the underneath of the cable bundle guide member 54 immediately about the cable bundle guide member 54 on which the protective insert 56 is installed, thereby preventing the cables as in 26 from being damaged by the underside of the cable bundle guide member 54. Alternatively, an epoxy coating could be applied to the guiding surface or a flange (not shown) or similar extension could be formed in the guiding surface in order to achieve the same effect.

Referring back to FIG. 2, the lips as in 57 of the cable bundle guides 54 illustratively can be extended upwards less than a patch panel width, such that when a succession of cable bundle guide members 54 (as illustrated) are mounted in a rack one on top of the other a gap remains between the guide members as in 54 such that the cables can still be introduced into the cable bundle guide members 54 such that they can rest on the plastic insert 56. The lips as in 57 are illustratively folded at a 90 degree angle to the elongate cable bundle guide member 54 in order to use less space in front of the panel 18.

Referring again to FIG. 3A, in order to retain the cables as in 26 against the cable management bar 32 and allow for regularisation of the gap between adjacent cables 26, and 262 as they pass over the cable management bar 32 (thereby reducing, for example, interference between the cables such as Alien NEXT), a cable guide 58 comprising a plurality of cable receiving portions as in 60 is provided along the cable management bar 32. In part for ease of installation, the plurality of cable receiving portions as in 60 are mounted as a group in a row on a guide support 62 which illustratively includes a pair of clips as in 64 for attaching the support 62 to the cable management bar 32, although in a particular embodiment the cable receiving portions as in 60 could also be installed individually on the cable management bar 32 with the provision of a suitable attachment means, such as a clip or through the use of an adhesive or the like, or could even be moulded into the cable management bar 32. As will now be apparent to a person of ordinary skill in the art, provision of the cable management bar 32 allows for a smooth change of direction of the cables as in 26 as the move from the conduit (reference 30 in FIG. 1) to the sockets as in 20 on the front of the patch panel 18.

Still referring to FIG. 3A, the use of clips as in 64 to secure the support 62 to the cable management bar 32 allows the cable guide 58 to be easily exchanged for different cable guide comprising different cable receiving portions as in 60, for example in order to accommodate different cable sizes or angles or the like. Although the cable receiving portions as in 60 can be enclosed, in order to allow cables as in 26 to be inserted into the guiding portion 66 of the cable receiving portions as in 60 without the necessity of removing the plug 28 from the end of the cable 26 (which would typically be required if the cable receiving portions as in 60 were enclosed), the cable receiving portions as in 60 each comprise a substantially cylindrical bore 68 and a longitudinal slot 70 for providing access fashioned therein. The cable receiving portions as in 60 can provide for full or partial locking of the patch cords or cables as in 26 in all or some directions and may also be capable of handling various sizes and geometric forms of patch cords or cables as in 26. In a particular embodiment the cable receiving portions as in 60 can be manufactured to include a ferrite core such that the cable receiving portions as in 60 act as a filter for suppressing electromagnetic interference.

Furthermore, an identification tag (not shown) or the like may be provided in proximity to the cable receiving portions as in 60, for example moulded into the cable receiving portions as in 60 themselves, for providing a means to differentiate between cables, for example through the use of colour, number or the like.

For a number of cable receiving portions as in 60 (illustratively for each six (6) cable receiving portions as in 60), the cable receiving portions as in 60, guide support 62 and clips as in 64 are typically formed from a single piece of material such as injected moulded plastic or the like. Alternatively, the cable receiving portions as in 60 can be manufactured from an electrical noise shielding ferromagnetic material in order to filter electrical noise and improve performance.

Additionally, the cable receiving portions as in 60 could each include a sensor (not shown) and interconnected with a monitoring system (also not shown) for automatically sensing the presence of a cable as in 26 in a cable receiving portions as in 60.

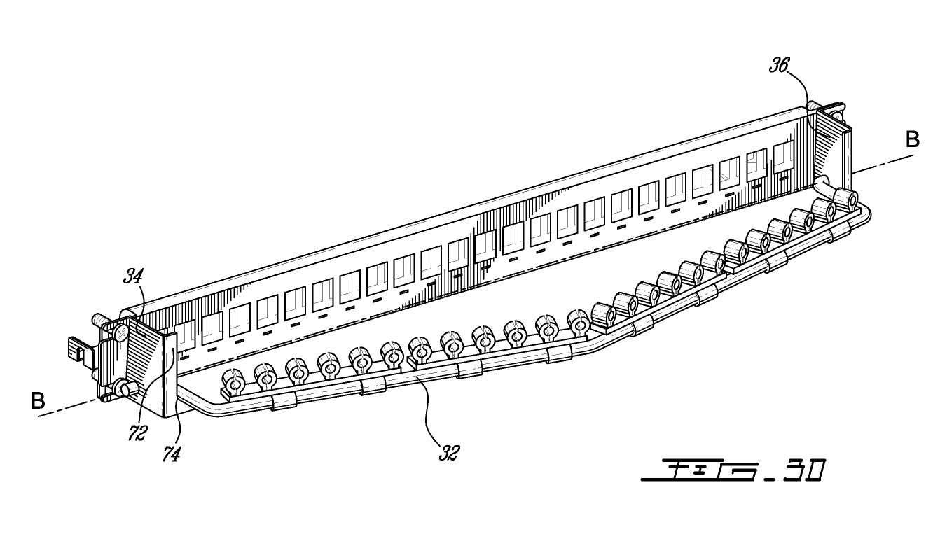

Of note, and referring to FIG. 4A in addition to FIG. 3A, is that in a particular embodiment the cable receiving portions as in 60 can be oriented relative to the guide support 62 such that the cables as in 26 form an angle θ with the cable management bar 32 as they pass over the cable management bar 32. This acute angle can be the same of different for each of the cable receiving portions as in 60 (for example, a progressively increasing or decreasing acute angle could be used for successive cable receiving portions as in 60. Alternatively, and referring now to FIG. 4B in addition to FIG. 3A, the cable receiving portions as in 60 can be oriented relative to the guide support 62 such that the cables as in 26 form a right angle with the cable management bar 32 as they pass over the cable management bar 32.

In an alternative embodiment the cable receiving portions as in 60 could be fashioned, though machining or moulding or the like, directly into the cable management bar 32, including one or all of the features as described hereinabove.

Note that although the cable guide 58 has been illustrated with the cable receiving portions as in 60 positioned above the cable management bar 32, in an alternative embodiment the cable receiving portions as in 60 could be positioned underneath the cable management bar 32, thereby supporting their respective cables underneath the cable management bar 32. Similarly, many patch bay panels as in 18 comprise two rows of sockets and as a result positioning cable guides as in 58 such that cable receiving portions as in 60 are found both on top of and underneath the cable management bar 32 may in some cases prove advantageous.

Referring now to FIG. 3D, in an alternative embodiment the mounting brackets 34, 36 could be provided without cable bundle guides (reference 52 in FIG. 3A). In this embodiment, provision can be made in the front ends as in 72 of the mounting brackets 34, 36 of a horizontal ledge 74 for limiting the cable management bar 32 to an upward rotation around axis A.

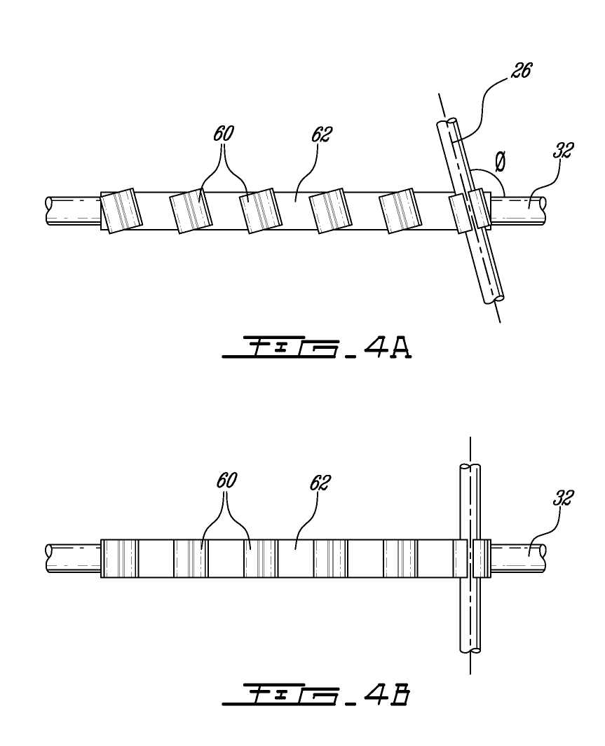

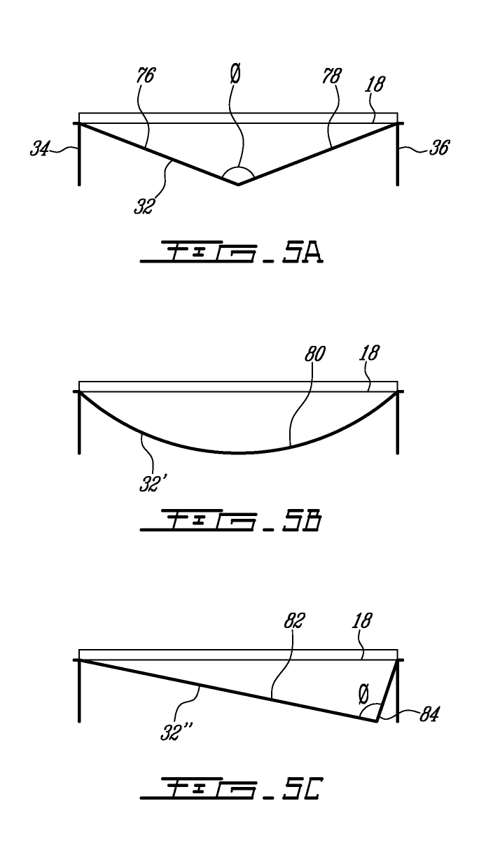

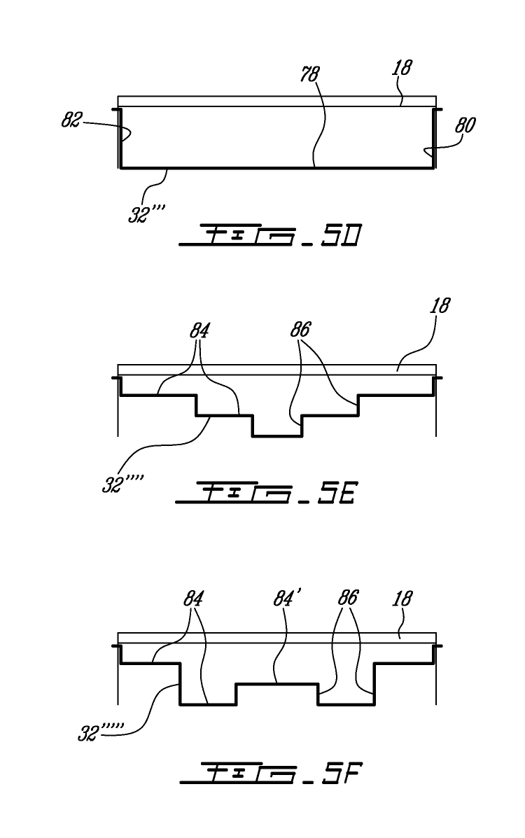

Referring now to FIG. 5A, the patch panel 18 of the present illustrative embodiment has been disclosed equipped with a channel management bar 32 comprised of two sections 76, 78 having equal length and interconnected at an angle φ, and supported at either end by a pair of mounting brackets 34, 36. Referring now to FIG. 5B, in an alternative embodiment, the cable management bar 32′ could be comprised of a single curved section 80. Referring now to FIG. 5C, in a second alternative embodiment, the cable management bar 32″ could be comprised of a pair of sections 76, 78 interconnected at an angle φ and having differing length. Referring now to FIG. 5D, in a third alternative embodiment, the cable management bar 32′″ could be comprised of one long centre section 86 and two shorter side sections 88, 90. Referring now to FIG. 5E, in a fourth alternative embodiment, the cable management bar 32″″ could be comprised of a number of staggered sections as in 92 interconnected by a series of interconnecting sections as in 94. Note that although the staggered sections as in 92 of FIG. 5E are shown arranged in parallel to the front of the patch panel 18, one or more of these sections could be arranged at an angle to the front of the patch panel 18. Additionally, although the interconnecting sections as in 94 are illustrated as being at right angles to the front of the patch panel 18, one or more of the interconnecting sections as in 94 could be at an angle to the front of the patch panel 18. Referring now to FIG. 5F, in a fifth alternative embodiment, the cable management bar 32′″″ the staggered sections as in 92 (interconnected by the interconnecting sections as in 94) could be alternatively staggered such that one or more of the sections (as in 92′) towards the centre of the cable management bar 32′″″ is closer to the front of the patch panel 18.

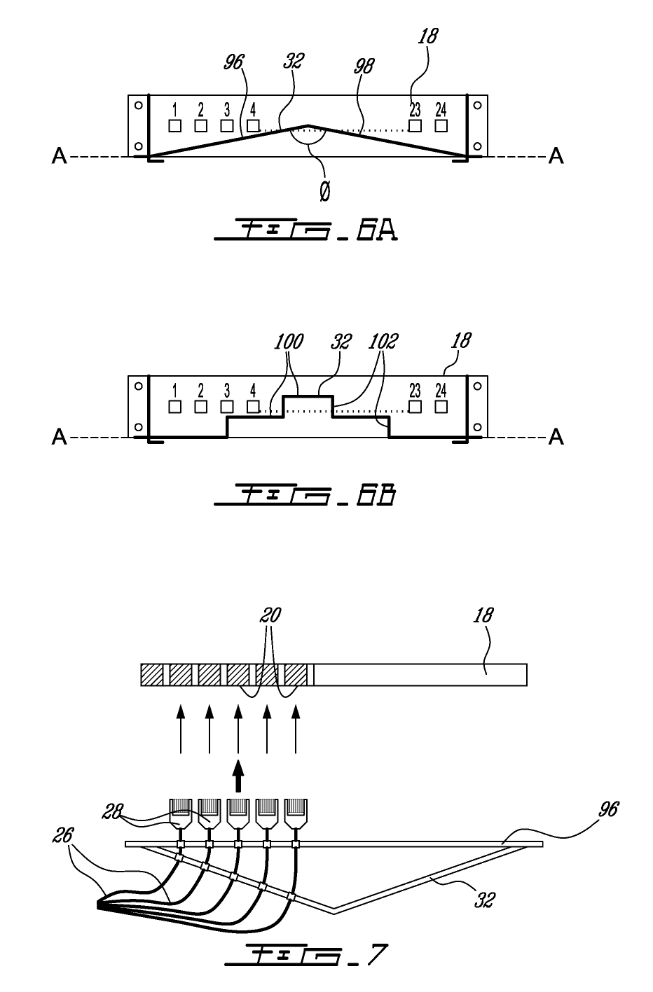

Referring now to FIG. 6A, although the cable management bar 32 has been illustrated hereinabove as being comprised of one or more sections which, when the cable management bar is in the horizontal position, lie in the same horizontal plane, in certain applications and also in order to, for example, increase spacing between cables as in 26 there by reducing crosstalk, the cable management bar can be comprised of two sections 98, 98 which, when the cable management bar 32 is in the horizontal position, are interconnected at an angle φ in the vertical. Referring now to FIG. 6B, in an alternative embodiment, the cable management bar 32 can be comprised of a series of sections as in 100 interconnected by interconnecting sections as in 102 where, when the cable management bar 32 is in the horizontal position, interconnecting sections as in 102 include a vertical component. Of course, in the illustrative embodiments presented hereinabove, the sections are also arranged in a horizontal direction such that an adequate spacing is maintained between the sections and the front face of the patch panel 18, thereby allowing the cable management bar 32 to pivot about the axis A. A person of skill in the art will now understand that other combinations of sections arranged in the horizontal and/or vertical directions are also possible.

Note that, although the above illustrative embodiments are directed towards a cable management bar 32 for guiding cables 26 to sockets as in 20 along the front of a patch panel 18, a similar assembly could be used to guide cables attached to the back of the patch panel 18. Additionally, although the above illustrative embodiments generally refer to patch panels 18 mounted on a cable management rack, the assembly of the present invention could also be used on active equipment (such as switches, servers, etc.), cross connecting equipment (patch panels, mini racks, cable management, etc.), etc. Additionally, although the above illustrative embodiments generally refer to a patch panel 18 comprising a number of RJ-45 sockets as in 20, the assembly of the present invention could also be used in conjunction with other communications technologies such as fibre optic cables and the like, either uniquely or in combination with other technologies.

Referring now to FIG. 7, in a further alternative illustrative embodiment the cable management bar 32 can be preloaded with one or more cables as in 26, allowing the plugs as in 28 of a series of cables as in 26 to be inserted simultaneously into the sockets as in 20 exposed along the front of the patch panel 18. Typically, this will require the addition of an additional supporting strut 104 for supporting the plugs as in 28 such that they mate correctly with the sockets as in 20. An additional assembly (not shown) could also be included to allow all the series of plugs as in 28 to be released simultaneously from the sockets as in 20 thereby allowing the series of cables as in 26 to be withdrawn using the cable management bar 32 (alternatively, the plugs as in 28 or sockets as in 20 could be modified such that they are not individually locked together when the plug as in 28 is inserted into its corresponding socket as in 20).

Note that although the above has been described using telecommunication cables, a person of skill in the art will understand that the present invention can also be applied in other cabling applications where a large number of cables are terminated substantially horizontally at a piece of equipment, for example in broadcasting applications, sound recording applications or electrical distribution applications and the like.

Although the present invention has been described hereinabove by way of an illustrative embodiment thereof, this embodiment can be modified at will without departing from the spirit and nature of the subject invention.

What is claimed is:

1. A cable management bar for attachment in front of an elongate panel mounted on a rack comprising a pair of vertical rails spaced at a predetermined distance from each other and bordering a surface, the panel comprising a face comprising a plurality of cable terminating elements therein, each of said elements terminating one of a plurality of cables, the bar comprising:
an elongate cable supporting portion; and
at least one mounting bracket for securing said cable supporting portion to one of the rails;
wherein a first distance between the surface and a first point along said cable supporting portion is less than a second distance between the surface and a second point along said cable supporting portion, said second point positioned farther from said mounting bracket than said first point.

2. The cable management bar of claim 1, wherein said elongate cable supporting portion is substantially straight and forms an acute angle with said surface.

3. The cable management bar of claim 1, wherein the face is a front face of the panel, wherein each of the plurality of cable terminating elements is a socket, wherein each of the cables is terminated by a plug and further wherein each of the sockets is adapted to receive the plug of one of the cables.

4. The cable management bar of claim 1, further comprising a plurality of cable guides arranged in a row along a surface of said at least one elongate section, each of said cable guides for guiding a respective one of the cables to a respective one of the cable terminating elements.

5. The cable management bar of claim 4, wherein said cable guides are arranged along an upper edge of said at least one elongate section.

6. The cable management bar of claim 4, wherein said cable guides are arranged along a lower edge of said at least one elongate section.

7. The cable management bar of claim 4, wherein said cable guides is substantially level with its respective cable terminating element.

8. The cable management bar of claim 4, wherein each of said cable guides comprises a guiding channel designed for receiving the respective cable.

9. The cable management bar of claim 8, wherein said guiding channel follows path substantially at right angles to said at least one elongate section.

10. The cable management bar of claim 3, wherein the cables are arranged along one side of the panel, wherein at least a portion of each of the cables between the panel side and the plug is substantially horizontal and further wherein each of said guiding channels follows a path designed such that the respective cable follows a substantially smooth curve between the panel side and the plug.

11. The cable management bar of claim 1, wherein when said mounting bracket is secured to the rack said at least one elongate cable supporting portion lies in a horizontal plane.

12. The cable management bar of claim 1, comprising two mounting brackets, wherein one of said brackets is attached at each end of said elongate cable supporting portion and wherein each of said brackets is secured to a respective one of the rack rails on opposite sides of the face.

13. The cable management bar of claim 1, wherein an upper surface of said at least one elongate section is arranged such that a path of each of the cables being supported by said at least one elongate section and their respective cable terminating elements lies in a substantially horizontal plain.

14. The cable management bar of claim 1, wherein said cable supporting portion comprises a pair of elongate sections interconnected at an obtuse angle.

15. The cable management bar of claim 14, wherein said pair of elongate sections are of equal length and form a “V” shape when viewed from above.

16. The cable management bar of claim 14, wherein said pair of elongate sections both lie in a plane substantially at right angles to the surface.

17. The cable management bar of claim 1, wherein said cable supporting portion is curved and lies in a plane substantially at right angles to the surface.

18. The cable management bar of claim 14, wherein said pair of elongate sections are interconnected at a point of intersection and further wherein when mounted to the rack a distance between the surface and said point of interconnection is greater than a distance between the surface and either of said elongate cable supporting sections.

19. The cable management bar of claim 1, wherein said cable supporting portion comprises at least two elongate sections, wherein when mounted to the rack said elongate sections are in parallel to the surface and further wherein a distance between the surface and a first of said sections is less than a distance between the surface and a second of said sections.

20. The cable management bar of claim 1, wherein said elongate cable supporting portion is pivotable about a first end between a cable supporting position where said at least one elongate section is positioned directly in front of the face and a face accessing position wherein said elongate cable supporting portion is positioned away from the face.

21. A panel comprising a face comprising a plurality of cable terminating elements, each of the elements adapted for terminating a cable, the panel comprising:
a cable management bar comprising at least one elongate cable supporting portion positioned in front of the face and a first end positioned to one side of the face;
wherein said cable management bar is pivotable about said first end between a cable supporting position where said at least one elongate section is positioned directly in front of the face and a face accessing position wherein said at least one elongate section is positioned away from the face.

22. The panel of claim 21, wherein said first end is pivotable about a vertical axis.

23. The panel of claim 22, wherein said cable management bar is pivotable away from the face between said cable supporting position and said cable accessing position.

24. The panel of claim 21, wherein said first end is pivotable about a horizontal axis.

25. The panel of claim 24, wherein the face is planar and further wherein the first end is pivotable about an axis substantially normal to the face.

26. The panel of claim 24, wherein the face is planar and further wherein said horizontal axis is at an acute angle to the face.

27. The panel of claim 26, wherein said acute axis angle is between 5 and 15 degrees.

28. The panel of claim 24, wherein the face is planar and further wherein said horizontal axis is parallel to the face.

29. The panel of claim 24, wherein said cable management bar is pivotable upwards between said cable supporting position and said cable accessing position.

30. The panel of claim 24, further comprising a locking mechanism for locking said cable management bar in said cable supporting position and further wherein when said locking mechanism is released, said cable management bar is pivotable downwards between said cable supporting position and said cable accessing position.

31. The panel of claim 28, wherein the face is planar and further wherein said at least one elongate cable supporting portion further comprises a second end positioned at an opposite side of the face to said first end, wherein said cable management bar is pivotable about both said first and second ends along said horizontal axis parallel to the front face and further wherein when in said cable supporting position said at least one elongate section lies in a plane substantially normal to the front face and when in said front face accessing position said at least one elongate section lies in a plane substantially parallel to the front face.

32. The panel of claim 21, wherein the front face is planar and further wherein said cable supporting portion is curved and further wherein, when in said cable supporting position, a distance between the front face and a centre of said curved portion is greater than a distance between the front face and a different point along said cable supporting portion.

33. The panel of claim 21, wherein said cable management bar comprises two elongate cable supporting portions interconnected at a point of interconnection at an angle.

34. The panel of claim 33, wherein said interconnection angle is between 0 and 90 degrees.

35. The panel of claim 33, wherein the face is planar and further wherein when in said cable supporting position, a distance between the front face and said point of interconnection is greater than a distance between the front face and either of said elongate cable supporting portions.

36. The panel of claim 33, wherein said elongate cable supporting portions are of equal length.

37. The panel of claim 33, wherein said elongate cable supporting portions are of different length.

38. The panel of claim 21, wherein said cable supporting portion is fabricated from a single piece of metal rod.

39. The panel of claim 21, wherein said cable management bar comprises of a plurality of elongate cable supporting portions arranged in parallel to a first direction and interconnected by a plurality of elongate interconnecting portions arranged at right angles to said first direction.

40. A cable guide for guiding one of a plurality of cables being supported by a cable management bar, the guide comprising:
a cable receiving portion for suspending the cable therein; and
an identification tag associated said cable receiving portion.

41. The guide of claim 40, wherein said cable receiving portion comprises a substantially cylindrical bore therein, a diameter of said bore slightly larger than a diameter of the cable.

42. The guide of claim 41, wherein said cable guide comprises a plurality of said cable receiving portion arranged in a row and a plurality of said identification tag and wherein an axis defined by said bore is at right angles to an axis defined by said row.

43. The guide of claim 41, wherein said cable receiving portion is fabricated from a resilient material and comprises a longitudinal slot between an outer surface of said cable receiving portion and said bore.

44. The guide of claim 40, further comprising at least one clip for securing said cable receiving portion and said identification tag to the cable management bar.

45. The guide of claim 40, wherein said cable receiving portion and said identification tag pivot relative to said clip about a vertical axis.

46. The guide of claim 40, wherein said cable guide comprises a plurality of said cable receiving portion arranged in a row and a plurality of said identification tag, one of said identification tag plurality associated with and in proximity to a respective one of said cable receiving portion plurality.

47. The guide of claim 46, wherein each of said identification tag plurality comprises a unique visual identifier.

48. The guide of claim 47, wherein said unique visual identifier is a color.

49. The guide of claim 47, wherein said unique visual identifier is a number.

50. The guide of claim 40, wherein each of said identification tag plurality comprises a unique RF ID tag.

51. The guide of claim 46, wherein said cable receiving portion plurality and said identification tag plurality are moulded into the cable management bar.

52. The guide of claim 46, further comprising a support interconnecting each of said cable receiving portion plurality and at least one clip for securing said support to the cable management bar and wherein said support, said cable receiving portion plurality and said at least one clip are moulded in a single piece of material.

53. The guide of claim 52, wherein said support, said cable receiving portion plurality, said at least one clip and said identification tag plurality are moulded in said single piece of material.

54. A cable guide for supporting at least one cable having a cable diameter between a vertical conduit and a respective one of at least one terminating elements in a horizontal panel mounted between a pair of vertical rails, the guide comprising:
an elongate member comprising a cable supporting edge;
a bracket at one end of said member for securing said member to one of the rails; and
a raised lip at an opposite end of said member from said bracket, said lip preventing the at least one cable from being removed from said cable supporting edge without raising the cable;
wherein when installed on said rack underneath and adjacent to a second like guide, an upper edge of said lip and a lower edge of a member of the second guide define a gap having a width which is greater than the cable diameter.

55. The cable guide of claim 54, further comprising a protective insert covering said cable supporting edge.

56. A method of simultaneously interconnecting a plurality of cables with a panel, the panel comprised of a plurality of equally spaced sockets arranged in a row and each of the plurality of cables being terminated by a plug, the method comprising:
providing a straight support bar comprising a row of equally spaced cable receiving portions arranged in a row along a surface thereof, wherein a spacing between adjacent cable receiving portions is the same as a spacing between adjacent ones of the equally spaced sockets;
securing a respective one of the plurality cables at a position immediately adjacent the plug in each of said cable receiving portions, wherein all of the plugs terminating the cables are arranged on one side of said bar; and
inserting said plurality of plugs into their respective sockets.
